(19) United States
(12) Patent Application Publication
(10) Pub. No.: US 2019/0381914 A1
(43) Pub. Date: Dec. 19, 2019

(54) TARGET SUPPORT DEVICE, VEHICLE CONTROL SYSTEM, VEHICLE CONTROL METHOD, VEHICLE CONTROL PROGRAM, AND SUPPORT STRUCTURE OF VEHICLE SEAT

(71) Applicant: HONDA MOTOR CO., LTD., Tokyo (JP)

(72) Inventor: Kazuyuki KANEKO, Wako-shi (JP)

(73) Assignee: Honda Motor Co., Ltd., Tokyo (JP)

(21) Appl. No.: 16/479,275

(22) PCT Filed: Jan. 24, 2017
(86) PCT No.: PCT/JP2017/002343

§ 371 Date: Jul. 19, 2019

(51) Int. Cl. B60N 2/02; G05D 1/00; B60W 10/20; B60W 10/04; B60W 10/18; B60W 50/08

(52) U.S. Cl. CPC B60N 2/0244; G05D 1/0088; B60W 10/20; B60W 10/04; B60W 10/18; B60W 2050/007; G05D 1/0061; G05D 2201/0213; B60W 2720/106; B60W 2710/20; B60W 50/082

(57) ABSTRACT

A target support device includes a bottom configured to be fixed to a floor of a vehicle and have a concave curved surface and three or more support members disposed on an upper side of the bottom and configured to come into contact with a convex curved surface formed on a lower surface of a target to support the target and have a surface which is formed as a curved surface.

### TECHNICAL FIELD

The present invention relates to a target support device, a vehicle control system, a vehicle control method, a vehicle control program, and a support structure of a vehicle seat.

### BACKGROUND ART

In recent years, technologies for controlling the positions of seats on which passengers sit based on travel states of vehicles have been studied. For example, technologies for causing a driving unit to operate in accordance with an output signal from a sensor that detects any one of a horizontal rotation position, a horizontal rotation speed, horizontal rotation acceleration, and acceleration in the horizontal direction of a vehicle and setting a seating portion of a seat to an optimum horizontal rotation position have been disclosed (for example, see Patent Literatures 1 and 2).

### CITATION LIST

### Patent Literature

### [Patent Literature 1]

Japanese Unexamined Patent Application, First Publication No. Hei 7-149171

### [Patent Literature 2]

Japanese Unexamined Patent Application, First Publication No. 2001-163098

### SUMMARY OF INVENTION

### Technical Problem

However, in the schemes of the technologies of the related art, since the driving unit moves the position of a seat based on an output signal from the sensor, smooth balance adjustment of the seat may not be achieved in some cases.

The present invention is devised in view of such circumstances and an object of the present invention is to provide a target support device, a vehicle control system, a vehicle control method, a vehicle control program, and a support structure of a vehicle seat capable of appropriately adjusting an attitude of a target in a vehicle.

### Solution to Problem

According to an aspect, there is provided a target support device including: a bottom configured to be fixed to a floor of a vehicle and have a concave curved surface; and three or more support members disposed on an upper side of the bottom and configured to come into contact with a convex curved surface formed on a lower surface of a target to support the target and have a surface which is formed as a curved surface.

According to another aspect, the target support device may further include a restriction portion configured to restrict a movement range of the support member on the bottom. Displacement of the target is restricted based on a movement range of the support member restricted by the restriction portion.

According to another aspect, in the target support device, the restriction portion may be a partition portion that protrudes upward from a curved surface of the bottom to form a wall surface.

According to another aspect, in the target support device, the restriction portion may be a concave portion provided on a curved surface of the bottom.

According to another aspect, in the target support device, the target may be a seat on which a passenger of the vehicle sits. The seat may include a driving operator that receives at least one operation between steering and an acceleration or deceleration speed of the vehicle.

According to another aspect, in the target support device, the target may be a seat on which a passenger of the vehicle sits. The target support device may further include a fixing portion that fixes the bottom and the seat.

According to another aspect, in the target support device, the fixing portion may fix the bottom and the seat by inserting a fixing member into each of holes formed in the bottom and the seat or a member connected to the seat.

According to another aspect, in the target support device, a tapered portion which is broadened on an insertion opening side of the fixing member may be formed in the hole.

According to another aspect, the target support device may further include a seat control unit configured to control a driving unit that moves a position of the seat. The seat control unit moves the seat to a predetermined position when the bottom and the seat are fixed.

According to another aspect, the target support device may include a suppression member configured to suppress a movement amount of the seat with respect to the bottom.

According to another aspect, there is provided a vehicle control system including: the target support device; an automated driving control unit configured to automatically control at least one of steering and an acceleration or deceleration speed of the vehicle; a switching control unit configured to switch between automated driving by the automated driving control unit and manual driving by a passenger of the vehicle; and a seat control unit configured to control a driving unit that moves a position of the seat.

According to another aspect, the vehicle control system further include a travel state recognition unit configured to recognize a travel state of the vehicle. The seat control unit moves the seat based on a travel state recognized by the travel state recognition unit.

According to another aspect, in the vehicle control system, the seat control unit fixes the bottom and the seat when the automated driving is switched to the manual driving by the automated driving control unit, and the seat control unit releases the fixing of the bottom and the seat when the manual driving is switched to the automated driving.

According to another aspect, there is provided a vehicle control method causing an in-vehicle computer to perform: automatically controlling at least one of steering and an acceleration or deceleration speed of a vehicle; switching between automated driving of the vehicle and manual driving by a passenger of the vehicle; and controlling a driving unit that moves a position of the seat by a target support device including a bottom that has a concave curved surface and is fixed to a floor of the vehicle when the automated driving is switched to the manual driving and three or more support members that have a surface which is formed as a curved surface and are disposed on an upper side of the bottom and comes into contact with a convex curved surface formed on a lower surface of a seat on which a passenger of the vehicle sits to support the seat.

According to another aspect, there is provided a non-transitory computer-readable storage medium that stores a vehicle control program causing an in-vehicle computer to perform: automatically controlling at least one of steering and an acceleration or deceleration speed of a vehicle; switching between automated driving of the vehicle and manual driving by a passenger of the vehicle; and controlling a driving unit that moves a position of the seat by a target support device including a bottom that has a concave curved surface and is fixed to a floor of the vehicle when the automated driving is switched to the manual driving and three or more support members that have a surface which is formed as a curved surface and are disposed on an upper side of the bottom and comes into contact with a convex curved surface formed on a lower surface of a seat on which a passenger of the vehicle sits to support the seat.

According to another aspect, there is provided a support structure of a vehicle seat mounted in a vehicle, wherein the seat is displaceable in a direction of an inertial force in accordance with acceleration operated on the vehicle and is returned to an original position in accordance with a decrease in the inertial force.

### Advantageous Effects of Invention

According to an aspect, the target support device can appropriately adjust an attitude of the target in the vehicle.

According to another aspect, the attitude of the target can be within a given range without considerably moving the target.

According to another aspect, the target support device can constantly maintain a distance between a passenger sitting on the seat and the driving operator. Therefore, the passenger can smoothly perform a driving operation of the vehicle even when the seat is moved.

According to another aspect, a passenger can switch movement and fixing of the seat in accordance with his or her preference. Further, the passenger can drive the vehicle in a stable state by fixing the seat.

According to another aspect, the target support device can fix the seat since the fixing members are slid toward the holes while being slid with the tapered portions even when the bottom and the seat or each of two or more holes formed in the members connected to the seat are deviated.

According to another aspect, the target support device can fix the seat at an appropriate position.

According to another aspect, since the target support device returns the moved seat to the original position by the suppression portions, a movement amount can be suppressed and the seat can return to the original position early.

According to another aspect, the vehicle control system can adjust an attitude of the seat in the vehicle appropriately in the automated driving and the manual driving.

According to another aspect, the vehicle control system can adjust an attitude of the seat in the vehicle more appropriately based on a travel state of the vehicle.

### BRIEF DESCRIPTION OF DRAWINGS

FIG. 1 is a diagram illustrating a configuration of a vehicle system 1 according to an embodiment.

FIG. 2 is a diagram illustrating an aspect in which a relative position and an attitude of a vehicle M with respect to a travel lane L1 are recognized by the own vehicle position recognition unit 122.

FIG. 3 is a diagram illustrating an aspect in which a target trajectory is generated based on a recommended lane.

FIG. 4 is a diagram illustrating an example of a configuration of a seat device 40.

FIG. 5 is a diagram illustrating an example of a concave portion formed on a curved surface of a bottom 41A.

FIG. 6 is a diagram illustrating an example of a seat device 40-1 that enables a seat 42 to move rotatably.

FIG. 7 is a diagram illustrating an example of a seat device 40-2 that enables the seat 42 to move within a rotatable movement and expansion range.

FIG. 8 is a diagram illustrating operations and advantageous effects of the seat device 40.

FIG. 9 is a diagram illustrating an attitude of the seat 42 when an inertial force occurs with respect to the seat 42.

FIG. 10 is a diagram illustrating an example of a configuration for fixing the seat 42 to the bottom 41.

FIG. 11 is a diagram illustrating an example of a state in which the bottom 41 and the seat 42 are fixed.

FIG. 12 is a diagram illustrating an example of a tapered portion installed in the bottom 41.

FIG. 13 is a diagram illustrating an example in which a tapered portion is formed in a part of the bottom side hole 49B.

FIG. 14 is a diagram illustrating an aspect in which the bottom 41 and the seat 42 are connected by a rubber member.

FIG. 15 is a diagram illustrating an aspect in which the bottom 41 and the seat 42 are connected by a spring member.

FIG. 16 is a diagram illustrating an aspect in which a magnet is set in each of the bottom 41 and the seat 42.

FIG. 17 is a diagram illustrating an example of a seat 42-1 including a table.

FIG. 18 is a diagram illustrating an example of a seat 42-2 including a driving operator 80.

FIG. 19 is a diagram illustrating an example of a seat 42-3 including an operation lever.

FIG. 20 is a diagram illustrating an example in which a cabin 300 is disposed on the bottom 41 in the vehicle M.

FIG. 21 is a flowchart illustrating an example of a vehicle control process according to an embodiment.

### DESCRIPTION OF EMBODIMENTS

Hereinafter, a target support device, a vehicle control system, a vehicle control method, a vehicle control program, and a support structure of a vehicle seat according to embodiments of the present invention will be described with reference to the drawings.

### [Overall Configuration]

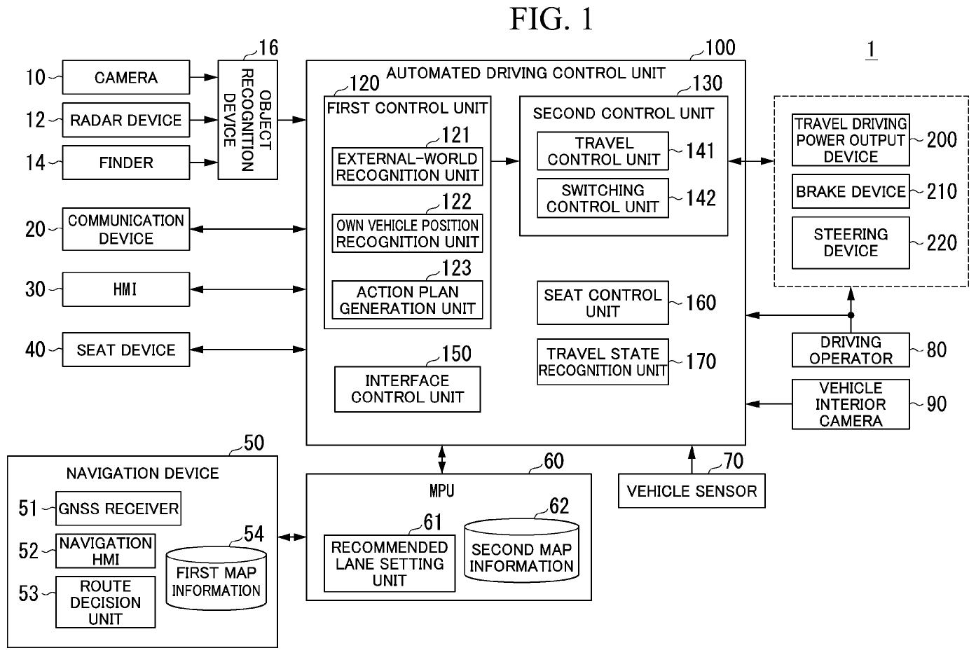

FIG. 1 is a diagram illustrating a configuration of a vehicle system 1 according to an embodiment. A vehicle (hereinafter referred to as a vehicle M) in which the vehicle system 1 is mounted is, for example, a vehicle such as a two-wheeled vehicle, a three-wheeled vehicle, or a four-wheeled vehicle. A driving source of the vehicle includes an internal combustion engine such as a diesel engine or a gasoline engine, an electric motor, and a combination thereof. The electric motor operates using power generated by a power generator connected to the internal combustion engine or power discharged from a secondary cell or a fuel cell.

The vehicle system 1 includes, for example, a camera 10, a radar device 12, a finder 14, an object recognition device 16, a communication device 20, a human machine interface (HMI) 30, a seat device 40, a navigation device 50, a micro processing unit (MPU) 60, a vehicle sensor 70, a driving operator 80, a vehicle interior camera 90, an automated driving control unit 100, a travel driving force output device 200, a brake device 210, and a steering device 220. The devices and units are connected to each other via a multiplex communication line such as a controller area network (CAN) communication line, a serial communication line, or a wireless communication network. The configuration illustrated in FIG. 1 is merely exemplary, a part of the configuration may be omitted, and another configuration may be further added.

In the first embodiment, the “vehicle control system” includes, for example, the seat device 40 and the automated driving control unit 100. The seat device 40 is an example of a “target support device.” A first control unit 120 and a second control unit 140 in the automated driving control unit 100 are an example of an “automated driving control unit.” The automated driving control unit automatically controls at least one of steering and an acceleration or deceleration speed of the vehicle M.

The camera 10 is, for example, a digital camera that uses a solid-state image sensor such as a charged coupled device (CCD) or a complementary metal oxide semiconductor (CMOS). The single camera 10 or the plurality of cameras 10 are mounted on any portion of the vehicle M in which the vehicle system 1 is mounted. In the case of forward imaging, the camera 10 is mounted on an upper portion of a front windshield, a rear surface of a rearview mirror, or the like. In the case of backward imaging, the camera 10 is mounted on an upper portion of a rear windshield, a backdoor, or the like. In the case of side imaging, the camera 10 is mounted on a door mirror or the like. For example, the camera 10 repeatedly images the periphery of the vehicle M periodically. The camera 10 may be a stereo camera.

The radar device 12 radiates radio waves such as millimeter waves to the periphery of the vehicle M and detects radio waves (reflected waves) reflected from an object to detect at least a position (a distance and an azimuth) of the object. The single radar device 12 or the plurality of radar devices 12 are mounted on any portion of the vehicle M. The radar device 12 may detect a position and a speed of an object in conformity with a frequency modulated continuous wave (FMCW) scheme.

The finder 14 is a light detection and ranging or a laser imaging detection and ranging (LIDAR) finder that measures scattered light of radiated light and detects a distance to a target. The single finder 14 or the plurality of finders 14 are mounted on any portion of the vehicle M.

The object recognition device 16 performs a sensor fusion process on detection results from some or all of the camera 10, the radar device 12, and the finder 14 and recognizes a position, a type, a speed, and the like of an object. The object recognition device 16 outputs a recognition result to the automated driving control unit 100.

The communication device 20 communicates with other vehicles around the vehicle M (an example of a nearby vehicle) using, for example, a cellular network, a Wi-Fi network, Bluetooth (registered trademark), dedicated short range communication (DSRC), or the like or communicates with various server devices via wireless base stations. The communication device 20 communicates with a terminal device carried by a person outside of the vehicle.

The HMI 30 suggests various types of information to passengers of the vehicle M and receives input operations by the passengers. For example, the HMI 30 includes various display devices, a speaker, a buzzer, a touch panel, a switch, and a key.

The seat device 40 is a seat on which a passenger of the vehicle M sits and is a seat which can be electrically driven. The seat device 40 includes a driving seat on which a passenger sits to manually drive the vehicle M using the driving operator 80, a front passenger seat on the lateral side of the driving seat, and back seats on the rear sides of the driving seat and the front passenger seat. In the following description, the “seat device 40” is at least one of the driving seat, the front passenger seat, and the back seats. A specific configuration of the seat device 40 will be described later.

The navigation device 50 includes, for example, a global navigation satellite system (GNSS) receiver 51, a navigation HMI 52, and a route decision unit 53 and retains first map information 54 in a storage device such as a hard disk drive (HDD) or a flash memory. The GNSS receiver 51 specifies a position of the vehicle M based on signals received from GNSS satellites. The position of the vehicle M may be specified or supplemented by an inertial navigation system (INS) using an output of the vehicle sensor 70. The navigation HMI 52 includes a display device, a speaker, a touch panel, and a key. The navigation HMI 52 may be partially or entirely common to the above-described HMI 30. The route decision unit 53 decides, for example, a route (including information regarding transit points when the vehicle travels until a destination) from a position of the vehicle M specified by the GNSS receiver 51 (or any input position) to the destination input by a passenger using the navigation HMI 52 with reference to the first map information 54. The first map information 54 is, for example, information in which a road form is expressed by links indicating roads and nodes connected by the links. The first map information 54 may include curvatures of roads and point of interest (POI) information. The route decided by the route decision unit 53 is output to the MPU 60. The navigation device 50 may perform route guidance using the navigation HMI 52 based on the route decided by the route decision unit 53. The navigation device 50 may be realized by, for example, a function of a terminal device such as a smartphone or a tablet terminal possessed by a user. The navigation device 50 may transmit a current position and a destination to a navigation server via the communication device 20 to acquire a route replied from the navigation server.

The MPU 60 functions as, for example, a recommended lane decision unit 61 and retains second map information 62 in a storage device such as an HDD or a flash memory. The recommended lane decision unit 61 divides a route provided from the navigation device 50 into a plurality of blocks (for example, divides the route in a vehicle movement direction for each 100 [m]) and decides a recommended lane for each block with reference to the second map information 62. The recommended lane decision unit 61 decides a lane in which the vehicle travels among the lanes located from the left. When there is a branching spot, a joining spot, or the like on the route, the recommended lane decision unit 61 decides a recommended lane so that the vehicle M can travel along a reasonable travel route for moving to a branching destination.

The second map information 62 is map information with higher precision than the first map information 54. The second map information 62 includes, for example, information regarding the middles of lanes or information regarding boundaries of lanes. The second map information 62 may include road information, traffic regulation information, address information (address and zip code), facility information, and telephone number information. The road information includes information indicating kinds of roads such as expressways, toll roads, national ways, or prefecture roads and information such as the number of lanes of a road, emergency parking areas, the width of each lane, the gradients of roads, the positions of roads (3-dimensional coordinates including longitude, latitude, and height), curvatures of curves of lanes, positions of joining and branching spots of lanes, and signs installed on roads. The second map information 62 may be updated frequently when the communication device 20 are used to access other devices.

The vehicle sensor 70 includes a vehicle speed sensor that detects a speed of the vehicle M, an acceleration sensor that detects acceleration, a yaw rate sensor that detects an angular velocity around a vertical axis, and an azimuth sensor that detects a direction of the vehicle M. More specifically, the acceleration sensor may detect vertical acceleration or a direction and magnitude of the horizontal acceleration of the vehicle M.

The driving operator 80 includes, for example, an accelerator pedal, a brake pedal, a shift lever, a steering wheel, and other operators. A sensor that detects whether there is an operation or an operation amount is mounted in the driving operator 80 and a detection result is output to the automated driving control unit 100 or the travel driving force output device 200 and one or both of the brake device 210 and the steering device 220.

The vehicle interior camera 90 images, for example, the upper half body of a passenger sitting on the seat device 40 centering on his or her face. For example, the vehicle interior camera 90 repeatedly images the passenger periodically. An image captured by the vehicle interior camera 90 is output to the automated driving control unit 100.

### [Automated Driving Control Unit]

The automated driving control unit 100 includes, for example, a first control unit 120, a second control unit 140, an interface control unit 150, a seat control unit 160, and a travel state recognition unit 170. Each of the first control unit 120, the second control unit 140, the interface control unit 150, the seat control unit 160, and the travel state recognition unit 170 is realized, for example, by causing a processor such as a central processing unit (CPU) to execute a program (software). Some or all of the function units of the first control unit 120 and the second control unit 140, the interface control unit 150, the seat control unit 160, and the travel state recognition unit 170 to be described below may be realized by hardware such as a large scale integration (LSI), an application specific integrated circuit (ASIC), or a field-programmable gate array (FPGA), or may be realized by software and hardware in cooperation.

The first control unit 120 includes, for example, the external-world recognition unit 121, the own vehicle position recognition unit 122, and the action plan generation unit 123.

The external-world recognition unit 121 recognizes states such as positions speeds, acceleration, or the like of nearby vehicles and based on information input from the camera 10, the radar device 12, and the finder 14 via the object recognition device 16. The positions of the nearby vehicles may be represented as representative points such as centers of gravity, corners, or the like of the nearby vehicles or may be represented as regions expressed by contours of the nearby vehicles. The “states” of the nearby vehicles may include acceleration or jerk of the nearby vehicles or “action states” (for example, whether the nearby vehicles are changing their lanes or are attempting to change their lanes).

The external-world recognition unit 121 may recognize guardrails, electric poles, parked vehicles, people such as pedestrians, and positions of other objects in addition to the nearby vehicles.

The own vehicle position recognition unit 122 recognizes, for example, a lane along which the vehicle M is traveling (a travel lane) and a relative position and an attitude of the vehicle M with respect to the travel lane. The own vehicle position recognition unit 122 recognizes, for example, the travel lane by comparing patterns of road mark lines (for example, arrangement of continuous lines and broken lines) obtained from the second map information 62 with patterns of road mark lines around the vehicle M recognized from images captured by the camera 10. In this recognition, the position of the vehicle M acquired from navigation device 50 or a process result by INS may be added.

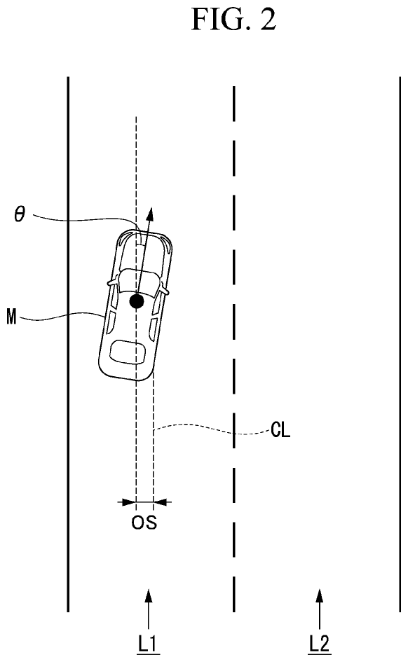

Then, the own vehicle position recognition unit 122 recognizes, for example, a position or an attitude of the vehicle M with respect to a travel lane. FIG. 2 is a diagram illustrating an aspect in which a relative position and an attitude of the vehicle M with respect to a travel lane L1 are recognized by the own vehicle position recognition unit 122. The own vehicle position recognition unit 122 recognizes, for example, a deviation OS from a travel lane center CL of a reference point (for example, a center of gravity) of the vehicle M and an angle θ formed with respect to a line drawn with the travel lane center CL in the movement direction of the vehicle M as the relative position and the attitude of the vehicle M with respect to the travel lane L1. Instead of this, the own vehicle position recognition unit 122 may recognize a position or the like of the reference point of the vehicle M with respect to one side end of the travel lane L1 as the relative position of the vehicle M with respect to the travel lane. The relative position of the vehicle M recognized by the own vehicle position recognition unit 122 is supplied to the recommended lane decision unit 61 and the action plan generation unit 123.

The action plan generation unit 123 generates an action plan for the vehicle M that performs automated driving to a destination or the like. For example, the action plan generation unit 123 decides events which are sequentially performed in automated driving control so that the vehicle M travels along the recommended lane decided by the recommended lane decision unit 61 and nearby situations of the vehicle M can be handled. As the events in the automated driving according to the embodiment, for example, there are a constant speed traveling event for traveling at a constant speed along the same travel lane, a lane changing event for changing a travel lane of the vehicle M, a passing event for passing a preceding vehicle, a following travel event for traveling and following a preceding vehicle, a joining event for joining vehicles at a joining spot, a branching event for causing the vehicle M to travel in a purpose direction at a branching spot of a road, an emergency stop event for urgently stopping the vehicle M, and a handover event for ending automated driving to switch the automated driving to manual driving. While such an event is being performed, an action for avoidance is planed based on a nearby situation (presence of a nearby vehicle or a pedestrian, lane constriction due to road construction, or the like) of the vehicle M in some cases.

The action plan generation unit 123 generates a target trajectory along which the vehicle M travels in future. The target trajectory includes, for example, a speed component. For example, the target trajectory is generated as a set of target spots (trajectory points) at which a vehicle arrives at a plurality of future reference times set for each predetermined sampling time (for example, about tenths of a second). Therefore, when an interval between trajectory points is large, it is assumed that the vehicle travels a section between the trajectory points at a high speed.

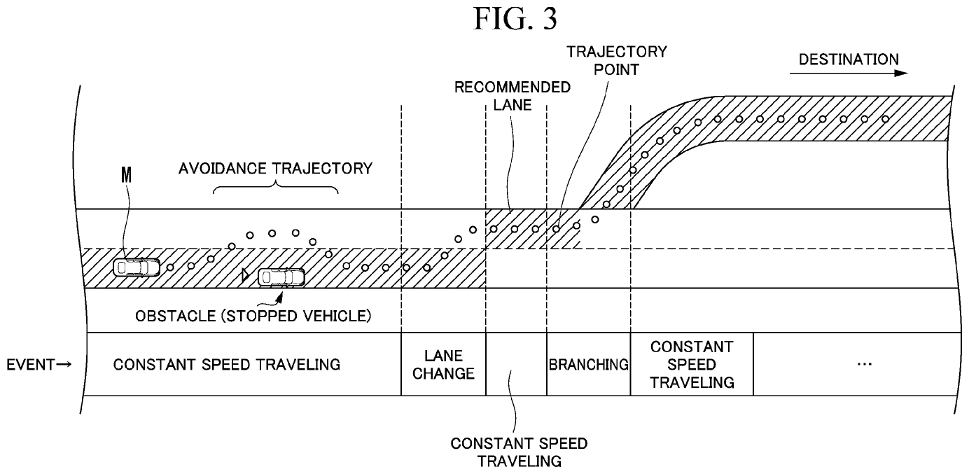

FIG. 3 is a diagram illustrating an aspect in which a target trajectory is generated based on a recommended lane. As illustrated, the recommended lane is set so that it is convenient to travel along a route to a destination. When the vehicle arrives within a predetermined distance in front of a switching spot of the recommended lane (which may be decided in accordance with a type of event), the action plan generation unit 123 activates a lane changing event, a branching event, a joining event, or the like. When it is necessary to avoid an obstacle during execution of each event, the action plan generation unit 123 may generate a trajectory for avoidance, as illustrated.

For example, the action plan generation unit 123 generates a plurality of candidates for the target trajectory and selects an optimum target trajectory suitable for the route to the destination at that time based on the perspective of safety and efficiency.

The second control unit 140 includes, for example, a travel control unit 141 and a switching control unit 142. The travel control unit 141 controls the travel driving force output device 200, the brake device 210, and the steering device 220 so that the vehicle M passes the target trajectory generated by the action plan generation unit 123 at a scheduled time.

The switching control unit 142 switches between driving modes of automated driving and manual driving based on, for example, a signal input from an automated driving switching switch provided in various operation switches of the HMI 30. The switching control unit 142 switches the driving mode of the own vehicle M from the automated driving to the manual driving based on, for example, an operation of giving an instruction to accelerate, decelerate, steer the driving operator 80 such as an accelerator pedal, a brake pedal, or a steering wheel. The switching control unit 142 switches between the automated driving and the manual driving based on an action plan generated by the action plan generation unit 123. In the manual driving, information input from the driving operator 80 is output to the travel driving force output device 200, the brake device 210, and the steering device 220. In addition, the information input from the driving operator 80 may be output to the travel driving force output device 200, the brake device 210, and the steering device 220 via the automated driving control unit 100. Each electronic control unit (ECU) of the travel driving force output device 200, the brake device 210, and the steering device 220 controls the manual driving on each device based on the information input from the driving operator 80 or the like.

The interface control unit 150 causes the HMI 30 to output a notification or the like related to a travel state of the automated driving or the manual driving of the vehicle M, a switching timing between the automated driving and the manual driving, a request for allowing a passenger to perform the manual driving, or the like. The interface control unit 150 may cause the HMI 30 to output information regarding control content by the seat control unit 160. The interface control unit 150 may output information received by the HMI 30 to the first control unit 120 or the seat control unit 160.

The seat control unit 160 controls an attitude or the like of the seat device 40 based on switching between the automated driving and the manual driving by the switching control unit 142 or an instruction from a passenger by the interface control unit 150. For example, the seat control unit 160 drives the seat device 40 using the seat driving device 45 so that the seat device 40 is placed at a predetermined position based on positional information from the seat position detection unit 46 to be described below. The seat control unit 160 performs fixing of the seat device 40 or releasing of the fixing when the driving mode is switched between the automated driving and the manual driving or an instruction is received from a passenger.

The seat control unit 160 may drive the seat device 40 based on an inertial force corresponding to a direction or magnitude of vertical acceleration or horizontal acceleration in the vehicle M obtained from a travel state of the vehicle M recognized by the travel state recognition unit 170. The details of the seat control will be described later.

The travel state recognition unit 170 recognizes a travel state of the vehicle M. For example, the travel state recognition unit 170 acquires a direction and magnitude of vertical acceleration or horizontal acceleration operated on the vehicle M by the vehicle sensor 70 in the vehicle M which is currently driving. The travel state recognition unit 170 may predict a direction and magnitude of vertical acceleration or horizontal acceleration received in future by the vehicle M on a slope road, a curved road, or the like in which the vehicle M travels from now from a target trajectory generated by the action plan generation unit 123 or the second map information 62.

The travel driving force output device 200 outputs a travel driving force (torque) for traveling the vehicle to a driving wheel. The travel driving force output device 200 includes, for example, a combination of an internal combustion engine, an electric motor and a transmission, and an electronic control unit (ECU) controlling these units. The ECU controls the foregoing configuration in accordance with information input from the travel control unit 141 or information input from the driving operator 80.

The brake device 210 includes, for example, a brake caliper, a cylinder that transmits a hydraulic pressure to the brake caliper, an electronic motor that generates a hydraulic pressure in the cylinder, and a brake ECU. The brake ECU controls the electric motor in accordance with information input from the travel control unit 141 or information input from the driving operator 80 such that a brake torque in accordance with a brake operation is output to each wheel. The brake device 210 may include a mechanism that transmits a hydraulic pressure generated in response to an operation of the brake pedal included in the driving operator 80 to the cylinder via a master cylinder as a backup. The brake device 210 is not limited to the above-described configuration and may be an electronic control type hydraulic brake device that controls an actuator in accordance with information input from the travel control unit 141 or information input from the driving operator 80 such that a hydraulic pressure of the master cylinder is transmitted to the cylinder. The brake device 210 may include a brake device of a plurality of systems in consideration of safety.

The steering device 220 includes, for example, a steering ECU and an electric motor. The electric motor applies a force to, for example, a rack and pinion mechanism to change a direction of a steering wheel. The steering ECU drives the electric motor to change the direction of the steering wheel in accordance with information input from the travel control unit 141 or information input from the driving operator 80.

### [Seat Control in Embodiment]

Hereinafter, a configuration of the seat device 40 and driving control of the seat device 40 by the seat control unit 160 according to the embodiment will be described. The vehicle M according to the embodiment includes the seat device 40 that adjusts an attitude of a target in the vehicle M to an appropriate attitude. In the vehicle M, the seat control unit 160 drives the seat device 40 based on each driving mode of the automated driving or the manual driving. The seat device 40 according to the embodiment can be moved in accordance with a travel state of the vehicle M or through an operation by a passenger even in a state in which the seat device 40 is not controlled by the seat control unit 160.

### [Configuration of Seat Device 40]

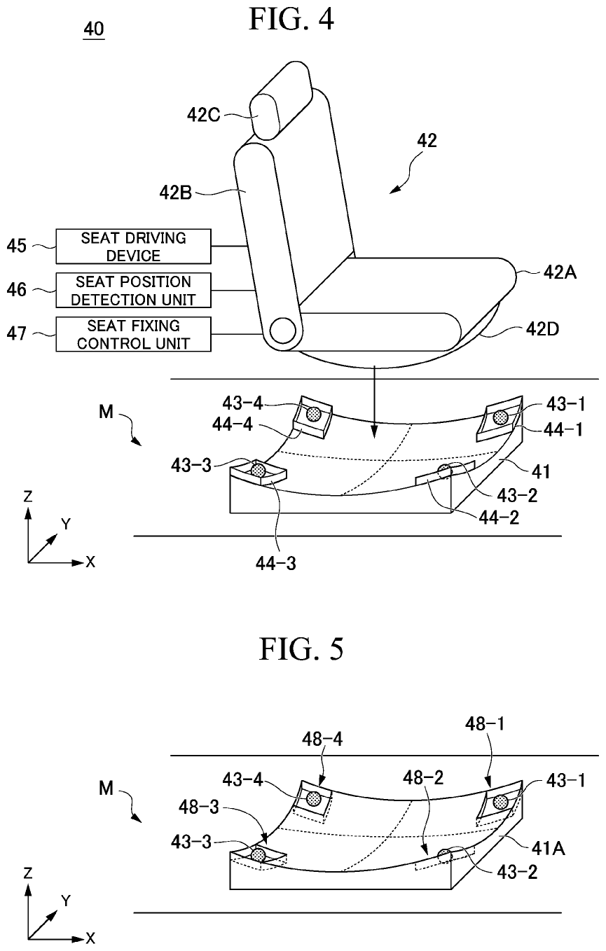

FIG. 4 is a diagram illustrating an example of a configuration of a seat device 40. The seat device 40 includes, for example, a bottom 41, a seat (seat body) 42, a spherical member 43, a partition portion 44, a seat driving device 45, a seat position detection unit 46, and a seat fixing control unit 47. FIG. 4 illustrates a state in which the bottom 41 is separated from the seat 42 to facilitate the description. The seat 42 is an example of a “target.” The spherical member 43 is an example of a “support member” of which a surface is formed as a curved surface. The partition portion 44 and the concave portion 48 (to be described below) are an example of a “restriction portion.” The seat driving device 45 is an example of a “driving unit.”

The bottom 41 is fixed to the floor of the vehicle M. A concave curved surface is formed on the upper side of the bottom 41 (the surface in the Z direction illustrated in FIG. 4). The concave curved surface is, for example, a spherical surface. On the concave curved surface, curved portions that are basically elliptical may be formed, for example, in the front, rear, right, and left of the vehicle M so as to move well.

The seat 42 includes, for example, a seating unit 42A, a backrest unit (seatback) 42B, a headrest 42C, and a base unit 42D. The seating unit 42A is a portion on which a passenger sits. The backrest unit 42B supports the back of the passenger sitting on the seating unit 42A. The headrest 42C supports the head of the passenger sitting on the seating unit 42A.

For example, the base unit 42D is formed to be integrated with the seating unit 42A. The base unit 42D may be a member that is detachably connected to the seating unit 42A. A convex curved portion is formed on the lower side of the base unit 42D (the −Z direction illustrated in FIG. 4) on the lower side. The convex curved surface is, for example, a spherical surface. The convex curved surface may be formed as a curved portion which is basically elliptical.

The spherical member 43 may be an elastic body such as rubber or may be formed of a resin, metal, or the like. Three or more spherical member 43 are disposed on the upper surface of the bottom and come into contact with the convex curved surface formed on the lower surface of a target to support the seat 42. In the example of FIG. 4, four spherical members 43-1 to 43-4 are illustrated. In the following description, the spherical members 43-1 to 43-4 have the same configuration. When the spherical members 43-1 to 43-4 are not distinguished from each other, the signs after the hyphens indicating which spherical members the spherical members 43-1 to 43-4 indicate are omitted and the spherical members 43-1 to 43-4 are referred to as the “spherical members 43” in the description. The same applies to other configurations denoted by hyphens.

The spherical members 43 are disposed at predetermined intervals in the bottom 41. In the example of FIG. 4, the spherical members 43 are disposed in the four corners of the rectangular bottom 41, but the present invention is not limited thereto. The diameter of the spherical member 43 is greater than the height of the partition portion 44. Therefore, the convex curved surface of the base unit 42D is supported by the spherical members 43 without coming into contact with the partition portions 44.

The concave curved portion of the bottom 41 and the convex curved surfaces of the spherical members 43 and the base unit 42D are formed by selecting a material for generating a predetermined frictional force or are subjected to surface finishing so that these cured portions do not slide in the contact portions (or the sliding is suppressed). In the embodiment, on the premise that the above-described sliding is allowed, a member that restricts relative displacement of the seat 42 and the bottom 41 within a predetermined range may be provided.

The partition portion 44 restricts a movement range of the spherical member 43. In the example of FIG. 4, the partition portions 44-1 to 44-4 are formed in four corners of the bottom 41. The partition portions 44 protrude upward from the bottom 41 to form side walls (wall surfaces). The partition portion 44 may be formed in a cylindrical shape. Each of the spherical members 43-1 to 43-4 is installed in each of the partition portions 44-1 to 44-4. The movement range of the spherical member 43 is restricted within a region surrounded by the side wall of the partition portion 44. Accordingly, a movable range of the base unit 42D of the seat 42 supported by the spherical members 43 is also restricted in association with the movement range of the spherical members 43. Thus, an attitude of the seat 42 can fall within a given range without considerable movement of the seat 42.

In the example of FIG. 4, the partition portion 44 restricting the movement range of the spherical member 43 is formed in a convex shape on the curved surface of the bottom 41, but a concave portion restricting the movement range of the spherical member 43 may be provided and the spherical member 43 may be disposed in the concave portion. FIG. 5 is a diagram illustrating an example of a concave portion formed on a curved surface of a bottom 41A. In the example of FIG. 5, concave portions 48-1 to 48-4 are formed in four corners on the curved surface of the bottom 41A. The diameter of the spherical member 43 is greater than the height of the concave portion 48. Therefore, the convex curved surface of the base unit 42D is supported by the spherical members 43 without coming into contact with the curved surface of the bottom 41A. The concave portions 48 may be entirely formed on the curved surface.

Each of the spherical members 43-1 to 43-4 is installed in each of the concave portions 48-1 to 48-4. The movement range of the spherical member 43 is restricted by the side wall of each concave portion 48. In this way, by forming the concave portions and moving the spherical members 43 to the concave portions, it is possible to restrict the movement range of the spherical members 43 as in the partition portions 44. It is possible to improve rigidity of the bottom 41 in which the concave portions 48 illustrated in FIG. 5 are formed further than when the partition portions 44 protruding upward are provided.

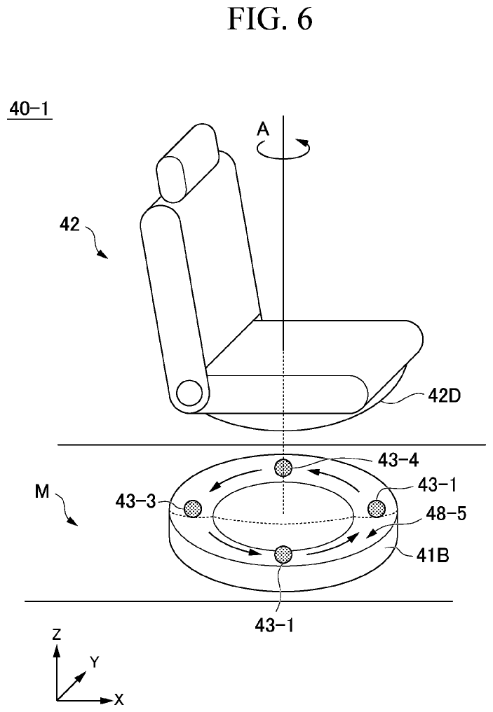

In the embodiment, for example, the seat device 40 may not be oriented in a movement direction of the vehicle M during the automated driving in some cases. Accordingly, the seat 42 may be configured to be rotatable. FIG. 6 is a diagram illustrating an example of a seat device 40-1 that enables a seat 42 to move rotatably. A bottom 41B is provided in a cylindrical shape, as illustrated.

A concave curved surface is formed on the upper portion of the bottom 41B. A concave portion 48-5 with a ring shape is formed on the curved surface of the concave portion. The spherical members 43-1 to 43-4 are disposed in the concave portion 48-5 at predetermined intervals. The spherical members 43 come into contact with the base unit 42D of the seat 42 so that the seat 42 is supported. The diameter of the spherical member 43 is greater than the height of the concave portion 48-5. Therefore, the convex curved surface of the base unit 42D is supported by the spherical members 43 without coming into contact with the curved surface of the bottom 41B.

The seat device 40-1 can rotate the seat 42 about the Z axis by 360 degrees by moving the spherical members 43 to the concave portion 48-5 with the ring shape. The rotation direction may be a direction A indicated by an arrow illustrated in FIG. 6 or may be a reverse direction to the direction A. Thus, a passenger of the vehicle M can rotatably move the seat 42 in a desired direction, for example, when it is not necessary to operate the driving operator 80 in the automated driving or the like.

For example, when an inertial force is operated in the front and rear directions or the right and left directions of the seat 42 by vertical acceleration or horizontal acceleration operated on the vehicle M in the bottom 41B illustrated in FIG. 6, the seat 42 can also be moved to the front, rear, right, or left by providing predetermined gaps between the spherical members 43 and the side wall of the concave portion 48-5 with the ring state.

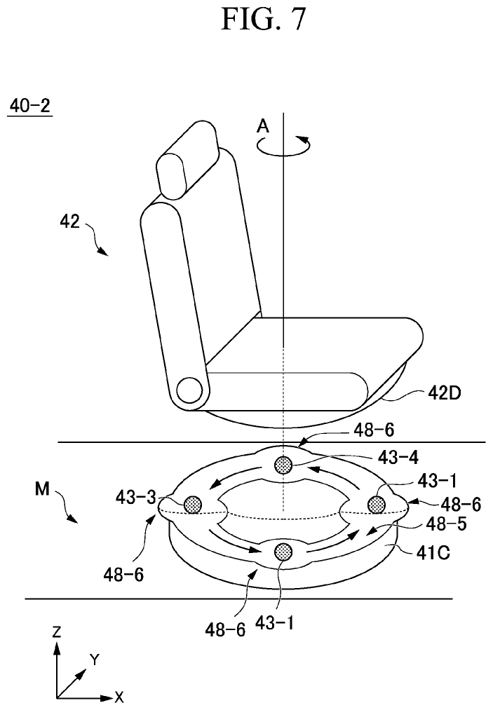

In the embodiment, when the spherical members 43 are located at a predetermined basic position of the concave portion 48-5 with the ring shape, the seat 42 may also be movable within an expanded range. FIG. 7 is a diagram illustrating an example of a seat device 40-2 that enables the seat 42 to move within a rotatable movement and expansion range. In the seat device 40-2 illustrated in the example of FIG. 7, expansion regions 48-6 are formed in the concave portion 48-5 with the ring shape of the bottom 41C, compared to the seat device 40-1 illustrated in FIG. 6.

For example, when the spherical member 43 is disposed in each of the expansion regions 48-6, the seat 42 is assumed to be located at the basic position. In the example of FIG. 7, the basic position of the seat 42 is, for example, a position at which the front face of the seat 42 is oriented in one of the ±X direction and the ±Y direction when the front face of the vehicle M is the X direction. When the seat 42 is located at the basic position, an attitude of the seat in the vehicle can be adjusted appropriately by expanding the movement range.

The seat driving device 45 changes a reclining angle of the seat 42, a position in the front, rear, right, or left direction, an attitude of the seat 42, or the like by driving a motor or the like based on an instruction of the seat control unit 160.

The seat driving device 45 drives a relative position of the seat 42 to the bottom 41. In this case, the seat driving device 45 may move the seat 42, for example, by moving the spherical members 43 to predetermined positions through a magnet operation. The magnet operation is, for example, an attractive phenomenon in which a permanent magnet is embedded in one of the seat 42 and the bottom 41 and an electromagnet is embedded in the other thereof and the electromagnet is operated.

The seat driving device 45 may adjust the position of the seat 42 by pressing the spherical members 43 in a predetermined direction by a rod-like press member provided on the side surface of the bottom 41. The seat driving device 45 may adjust the position of the seat 42 by drawing the spherical members 43 in a predetermined direction using wires connected to the spherical members 43. The seat driving device 45 may rotatably drive the spherical members 43 by the principle of an induction motor when the spherical members 43 are formed of a ferromagnetic substance. The seat driving device 45 may adjust the position of the seat 42 by fitting the spherical members 43 in gears connected to the motor and rotatably driving the spherical members 43 in a predetermined direction when grooves are formed in the spherical members 43. The seat driving device 45 may adjust the position of the seat 42 by combining a plurality of schemes among the above-described schemes.

The seat position detection unit 46 detects displacement, a yaw angle, or the like from the reclining angle of the seat 42 and the basic position in the front, rear, right, or left. The seat position detection unit 46 outputs the detected result to the seat control unit 160.

The seat fixing control unit 47 fixes the bottom 41 and the seat 42 using the seat fixing portion 49 (to be described below) based on an instruction of the seat control unit 160. The seat fixing portion 49 is an example of a “fixing unit.” A specific example of control by the seat fixing control unit 47 will be described later.

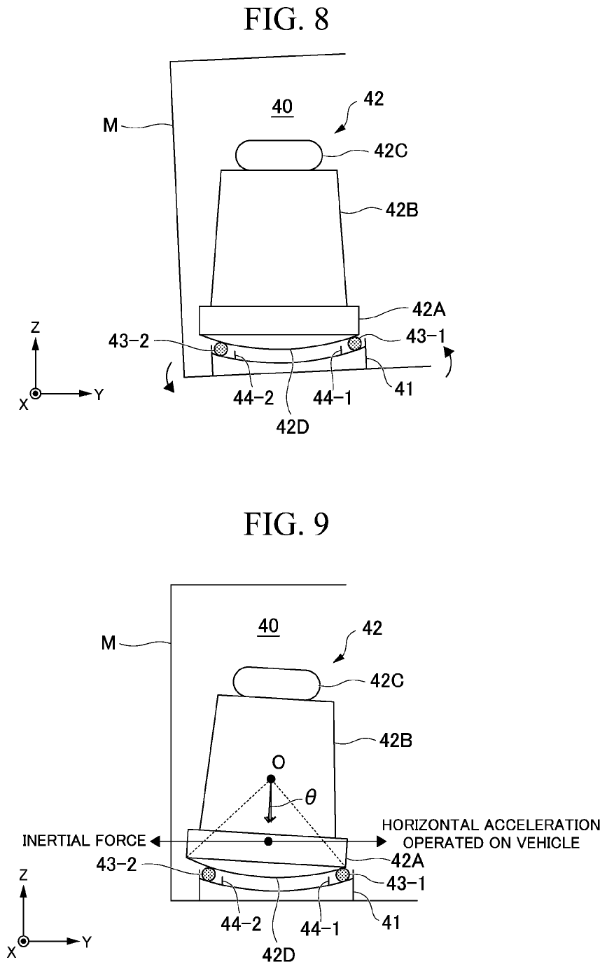

Next, examples of operations and advantage effects in the configuration of the above-described seat device 40 will be described. FIG. 8 is a diagram illustrating operations and advantageous effects of the seat device 40. In the example of FIG. 8, a part of the sectional view of the vehicle M when the vehicle M is viewed in the front direction (the −X direction) is illustrated. In the example of FIG. 8, a state in which the vehicle M is traveling on a slope surface inclined downward to the right side in the travel direction (the X direction) is illustrated. In this case, since the bottom 41 is fixed to the floor of the vehicle M, the bottom 41 is inclined in the same direction as the slope surface (here, contribution of a suspension is not considered). On the other hand, since the seat 42 is supported by the spherical members 43, an attitude of the seat 42 is adjusted so that the central axis of the seat 42 is oriented in the center-of-gravity direction (the −Z direction illustrated in FIG. 8) by rotating the spherical members 43. Therefore, discomfort of a passenger sitting on the seat 42 with respect to an inclination of the vehicle M is reduced since an inclination of the human body in the horizontal direction is suppressed. In this way, the seat device 40 can appropriately adjust the attitude of the seat 42 in the vehicle M.

FIG. 9 is a diagram illustrating an attitude of the seat 42 when an inertial force occurs with respect to the seat 42. In the example of FIG. 9, a part of the sectional view of the vehicle M when the vehicle M is viewed in the front direction (the −X direction) is illustrated as in FIG. 8. For example, when the vehicle M is traveling on a left curved road in the movement direction (the X direction), horizontal acceleration is operated on the left side (the right side illustrated in FIG. 9) in the movement direction of the vehicle M. Accordingly, an inertial force is operated on the seat 42 on the right side (the left side illustrated in FIG. 9) in the movement direction of the vehicle M. In this case, although the seat 42 is moved by the spherical members 43 in the −Y direction by the spherical members 43, the seat 42 is inclined by an angle θ setting a center of a sphere corresponding to a curved surface as a reference because of the convex curved shape of the base unit 42D. Thus, it is possible to prevent a passenger from being horizontally shaken due to the inertial force on the passenger of the vehicle M and stabilize an attitude.

That is, in the configuration according to the embodiment, the seat device 40 has a support structure that can be displaced in the direction of an inertial force in accordance with acceleration operated on the vehicle M and return to the original position in accordance with a decrease in the inertial force. In the example of FIG. 9, the inertial force moves the seat 42 in the horizontal direction, but this force is operated in a rotational direction setting a center O of the sphere forming the convex curved surface of the base unit 42D as a reference. In the drawing, θ indicates a rotational angle. As a result, acceleration in the horizontal direction is prevented from being abruptly operated on the passenger. Accordingly, it is possible to reduce the discomfort of the passenger. Further, in the configuration according to the embodiment, since the seat 42 is moved in the rotational direction due to the convex curved surface of the base unit 42D, the seat 42 can automatically be returned to the origin despite no control of the seat by the seat driving device 45.

When the travel state recognition unit 170 predicts the horizontal acceleration which is currently received by the vehicle M or horizontal acceleration which will be received in future, the seat control unit 160 may move the seat 42 to the position illustrated in FIG. 9 using the seat driving device 45. Thus, acceleration in the horizontal direction is prevented from being abruptly operated on the passenger. Accordingly, it is possible to stabilize the attitude of the passenger.

In the example of FIG. 9, the examples of the operations and the advantageous effects for the horizontal acceleration have been described, but similar operations and advantageous effects for vertical acceleration are obtained. In the embodiment, the base unit 42D supported by the spherical members 43 has the convex curved surface. Therefore, when both vertical acceleration and horizontal acceleration are operated on the vehicle M or when a ratio of the vertical acceleration to the horizontal acceleration operated on the vehicle M varies, the seat 42 can be smoothly moved without discomfort.

A movement amount of the seat 42 by the spherical members 43 depends on a movement range of the spherical members 43. Therefore, by forming the partition portions 44 or the concave portions 48 described above, it is possible to restrict the movement amount of the seat 42. Thus, the passenger can maintain his or her attitude more stably.

### [Fixing Seat 42]

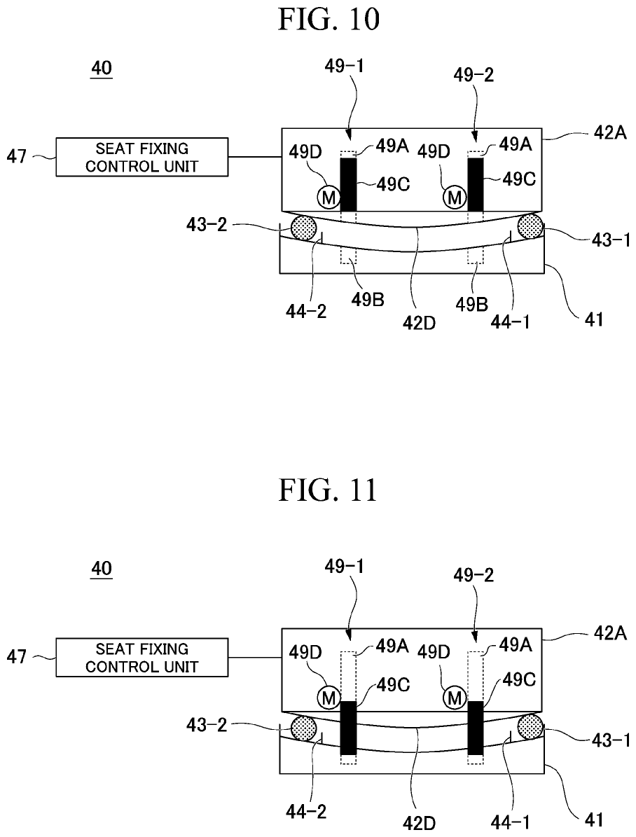

Next, fixing of the seat 42 to the bottom 41 by the seat fixing control unit 47 will be described. FIG. 10 is a diagram illustrating an example of a configuration for fixing the seat 42 to the bottom 41. FIG. 10 schematically illustrates a configuration necessary to describe a configuration of a fixing portion of the seat device 40. The same applies to FIGS. 11 to 13 to be described below.

For example, when the seat of the vehicle M is activated in the manual driving, a distance or an angle between the driving operator 80 and a passenger sitting on the seat is changed. Therefore, driving is difficult in some cases. Accordingly, in the embodiment, the seat 42 is fixed to the bottom 41 by the seat fixing control unit 47 in the manual driving. In the embodiment, for example, by receiving an instruction of the passenger from the HMI 30, fixing and retention of the seat 42 can be selected in accordance with preference of the passenger.

The seat device 40 includes, for example, one fixing portion 49 and a plurality of fixing portions 49. In the example of FIG. 10, two seat fixing portions 49-1 and 49-2 are included. The seat fixing portions 49-1 and 49-2 are installed at a predetermined interval.

The seat fixing portion 49 includes a seat side hole 49A, a bottom side hole 49B, a fixing member 49C activating the insides of the seat side hole 49A and the bottom side hole 49B, and a motor 49D activating the fixing member 49C. The fixing member 49C is formed of, for example, a metal. The fixing member 49C is, for example, a rod-like member. The fixing member 49C may be a plate-shaped member or may be a claw-shaped member. The motor 49D vertically moves the fixing member 49C.

FIG. 11 is a diagram illustrating an example of a state in which the bottom 41 and the seat 42 are fixed. When the bottom 41 and the seat 42 are fixed, the seat fixing control unit 47 drives the motor 49D to move the fixing member 49C downward and insert the fixing member 49C to the bottom side hole 49B. Thus, as illustrated in FIG. 11, the seat 42 is fixed to the bottom 41 by the fixing members 49C in a state in which the seat 42 is supported by the spherical members 43 on the bottom 41. Thus, the seat 42 is fixed inside the vehicle M. Accordingly, the passenger can perform the manual driving or the like of the vehicle M by operating the driving operator 80.

In the manual driving, the seat fixing control unit 47 drives the motor 49D to move onto the fixing members 49C and accommodate the fixing members 49C inside the seat side holes 49A. Thus, the fixing of the seat 42 is released. The seat fixing portions 49 are not limited to the above-described configuration and may be fixed using, for example, an electromagnet or the like.

When the bottom 41 and the seat 42 are fixed, the seat control unit 160 may cause the seat driving device 45 to move the seat 42 to a predetermined position and may subsequently cause the seat fixing control unit 47 to fix the bottom 41 and the seat 42. Thus, it is possible to fix the seat 42 at an appropriate position.

In the embodiment, when the fixing member 49C is driven in a state in which the positions of the seat side hole 49A and the bottom side hole 49B are deviated, a tapered portion may be formed in the upper portion of the bottom side hole 49B so that the fixing member 49C is inserted into the bottom side hole 49B.

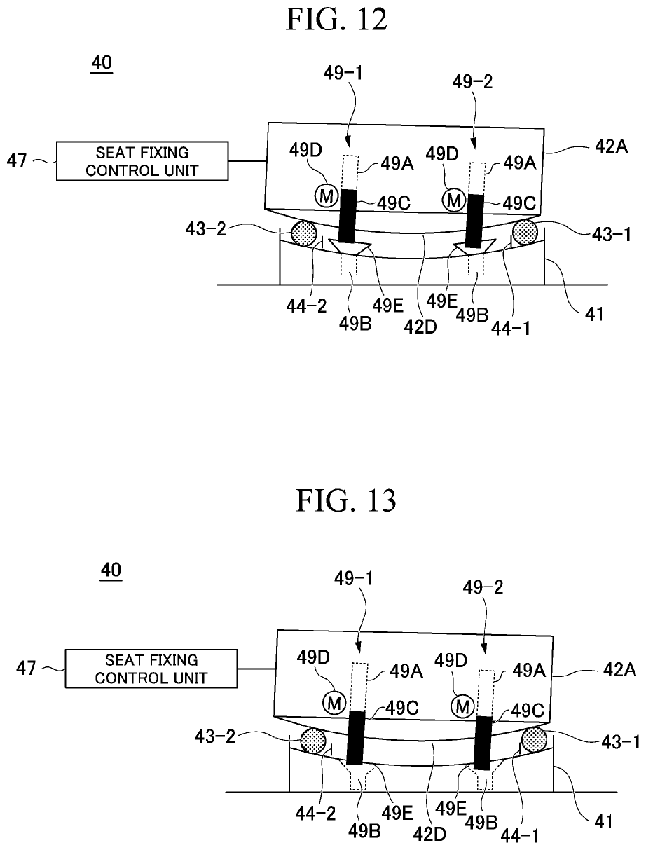

FIG. 12 is a diagram illustrating an example of a tapered portion installed in the bottom 41. In the example of FIG. 12, a tapered portion 49E protruding so that it is gradually broadened on an insertion opening side of the fixing member 49C is provided in the upper portion of the bottom side hole 49B. The size of the insertion opening is preferably, for example, the size corresponding to the movement range of the seat 42. Thus, even when the seat 42 is inclined, the seat 42 can be fixed since the fixing members 49C are inserted into the tapered portions 49E to be slid toward the bottom side holes 49B while the fixing members 49C are slid on the side surfaces of the tapered portions 49E.

The tapered portion according to the embodiment may be formed in a part of the bottom side hole 49B. FIG. 13 is a diagram illustrating an example in which the tapered portion is formed in the part of the bottom side hole 49B. In the example of FIG. 13, a tapered portion 49F that is gradually broadened on the insertion opening side of the fixing member 49C is formed in the bottom side hole 49B. Thus, as in the example of FIG. 12, even when the seat 42 is inclined, the fixing member 49C is inserted into the bottom side hole 49B so that the seat 42 can be fixed to the bottom 41. As illustrated in FIG. 13, by forming the tapered portion 49F in the bottom side hole 49B, it is possible to form the tapered portion in the integrated manner and further improve rigidity than the tapered portion 49E illustrated in FIG. 12.

In the above-described embodiment, the bottom 41 and the seat 42 are fixed by inserting the fixing members 49C into the bottom side holes 49B from the side of the seat side holes 49A. However, the bottom 41 and the seat 42 may be fixed by inserting the fixing members 49C accommodated in the bottom side holes 49B into the seat side holes 49A. In this case, the tapered portions 49E or 49F are formed on the seat side.

### [Suppression of Movement Amount of Seat 42 to Bottom 41]

Next, suppression of a movement amount of the seat 42 to the bottom 41 will be described. In the embodiment, the seat device 40 may include a suppression member that suppresses a movement amount of the seat 42 to the bottom 41 between the bottom 41 and the seat 42. The suppression member is, for example, an elastic body such as a rubber member or a spring member. The suppression member may be an object that generates a magnetic force.

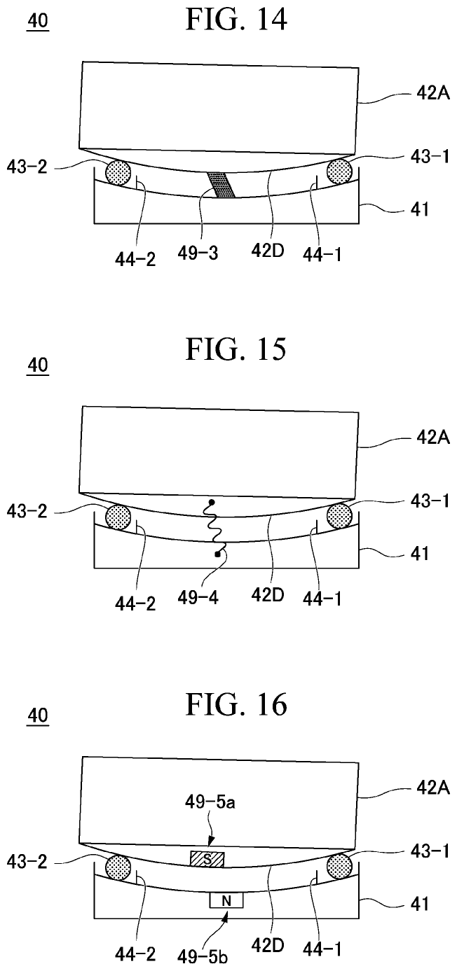

FIG. 14 is a diagram illustrating an aspect in which the bottom 41 and the seat 42 are connected by a rubber member. In the example of FIG. 14, the simplified seat device 40 is illustrated to describe a positional relation between the suppression member, and the bottom 41 and the seat 42. The same applies to FIGS. 15 and 16 to be described below. In the examples from FIGS. 14 to 16, aspects in which the seat 42 is moved from the original position with respect to the bottom 41 are illustrated.

In the example of FIG. 14, the bottom 41 and the base unit 42D of the seat 42 are connected by a rubber member 49-3. The rubber member 49-3 is installed so that a repulsive force does not occur when the bottom 41 and the seat 42 are at a reference position (the original position). The seat 42 is connected to the bottom 41 by the rubber member 49-3, and thus the seat 42 can be moved by a movement amount corresponding to the repulsive force of the rubber member 49-3 with respect to the bottom 41. Since the seat 42 returns to the original position by the repulsive force of the rubber member 49-3 after the movement, the movement amount can be suppressed and the seat 42 can return to the original position early. The plurality of rubber members 49-3 may be installed between the bottom 41 and the seat 42.

FIG. 15 is a diagram illustrating an aspect in which the bottom 41 and the seat 42 are connected by a spring member. In the example of FIG. 15, the bottom 41 is connected to the base unit 42D of the seat 42 by a spring member 49-4. The spring member 49-4 is installed so that a repulsive force does not occur when the bottom 41 and the seat 42 are at a reference position (the original position). The seat 42 is connected to the bottom 41 by the spring member 49-4, and thus the seat 42 can be moved by a movement amount corresponding to the repulsive force of the spring member 49-4 with respect to the bottom 41. Since the seat 42 returns to the original position by the repulsive force of the spring member 49-4, the movement amount can be suppressed and the seat 42 can return to the original position early. The plurality of spring members 49-4 may be installed between the bottom 41 and the seat 42.

FIG. 16 is a diagram illustrating an aspect in which a magnet is set in each of the bottom 41 and the seat 42. In the example of FIG. 16, an S-pole magnet 49-5a is installed in the base unit 42D of the seat 42 and an N-pole magnet 49-5b is installed in the bottom 41, but the reverse magnets may be installed. The magnets 49-5a and 49-5b are installed at closest positions (for example, lined positions in the vertical direction) when the bottom 41 and the seat 42 are at a reference position (the original position). When the magnet is disposed to be close to the other magnet, an attraction force works between the magnets 49-5a and 49-5b. Accordingly, the seat 42 returns to the original position, the movement amount can be suppressed and the seat 42 can return to the original position early. The pluralities of magnets 49-5a and 49-5b may be installed between the bottom 41 and the seat 42.

### [Other Examples of Target]

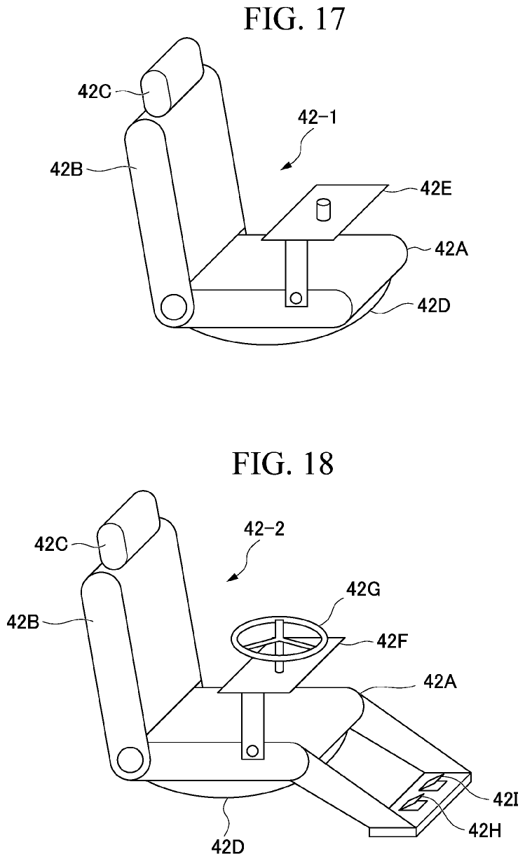

In the above-described embodiment, the seat 42 has been used as an example of a “target,” but a table may be used as a “target” in addition (or instead of) the above-described seat 42. FIG. 17 is a diagram illustrating an example of a seat 42-1 including a table. The seat 42-1 illustrated in FIG. 17 includes, for example, the seating unit 42A, the backrest unit 42B, the headrest 42C, the base unit 42D, and a table 42E. In the example of FIG. 17, the table 42E is installed in, for example, the seating unit 42A, but may be installed in the base unit 42D or may be installed in the backrest unit 42B. The table 42E may be detachably mounted in the seat 42-1. The table 42E may be folded to be able to be accommodated inside or a side of the seat 42-1.

The seat 42-1 is supported by the spherical members 43 on the bottom 41, so that the attitudes of the seat 42-1 and the table 42E can appropriately be adjusted. Thus, for example, even when a passenger places a cup or the like in which a drink is input on the table 42E, spilling of the drink or falling of the cup can be decreased in accordance with a travel state or the like of the vehicle M. The “target” may be a drink holder or the like.

In the embodiment, for the “target,” the above-described seat device 40 may include at least a part of the driving operator 80 such as a steering wheel, an accelerator pedal, or a brake pedal. FIG. 18 is a diagram illustrating an example of a seat 42-2 including a driving operator 80. In the example of FIG. 18, the seat 42-2 includes a frame 42F installed in the seating unit 42A and a steering wheel 42G installed in the frame 42E The seat 42-2 includes an accelerator pedal 42H and a brake pedal 42I. As illustrated in FIG. 18, the seat 42-2 includes at least a part of the driving operator 80. Thus, when the seat 42-2 is moved, the steering wheel 42G, the accelerator pedal 42H, and the brake pedal 42I are moved along with the seat 42-2. Therefore, a distance between the driving operator 80 and a passenger sitting on the seat 42-2 can be maintained constantly. Therefore, even when the seat 42-2 is moved, the passenger can smoothly perform a driving operation on the vehicle M.

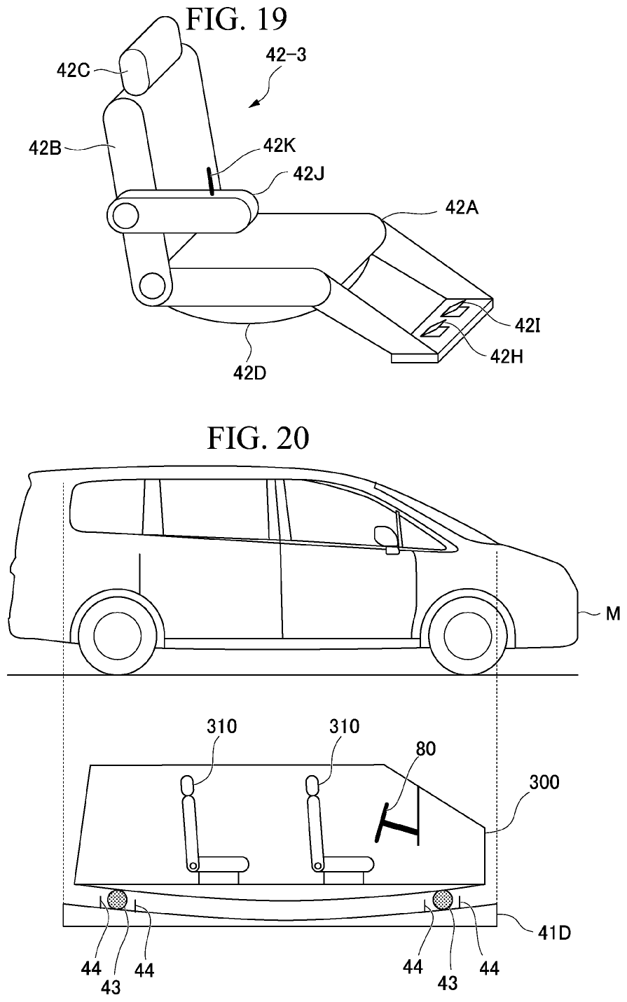

FIG. 19 is a diagram illustrating an example of a seat 42-3 including an operation lever. The seat 42-3 illustrated in the example of FIG. 19 includes an armrest 42J installed in the backrest unit 42B and an operation lever 42K installed in the armrest 42J. The seat 42-3 includes the accelerator pedal 42H and the brake pedal 42I as in the seat 42-2.

The operation lever 42K is an example of the driving operator 80. The operation lever 42K performs control related to steering of the vehicle M as in the steering wheel 42G. As illustrated in FIG. 19, by providing the operation lever 42K instead of the steering wheel 42G, it is possible to dispose the driving operator 80 related to the steering at a position at which there is no interruption to a passenger. Therefore, even when the seat 42-3 is moved, the passenger can smoothly perform a driving operation on the vehicle M.

The “target” may be an entire cabin configured in the vehicle M. FIG. 20 is a diagram illustrating an example in which a cabin 300 is disposed on the bottom 41 in the vehicle M. In the example of FIG. 20, the outer form of the vehicle M and the interior of the vehicle M are separately illustrated to facilitate the description.

In the example of FIG. 20, the cabin 300 includes the driving operator 80 and the seat 310 on which a passenger sits. The lower surface of the cabin 300 has a convex curved surface. The seat 310 is fixed to the cabin 300. The spherical members 43 and the partition portions 44 are included on the upper surface of the bottom 41D. The upper surface of the bottom 41D has a concave curved surface. In the case of the example illustrated in FIG. 20, the seat control unit 160 of the automated driving control unit 100 is replaced with a cabin control unit. Similarly, the seat 42 is replaced with the cabin 300. Accordingly, the cabin control unit controls position detection of the cabin 300, fixing of the cabin 300 or release of the fixing, driving of the cabin 300, or the like.

As illustrated in FIG. 20, the lower surface of the cabin 300 is supported by the spherical members 43 provided on the bottom 41D, so that the entire cabin 300 can be appropriately adjusted in accordance with a driving mode or a travel state of the vehicle M.

### [Vehicle Control Process]

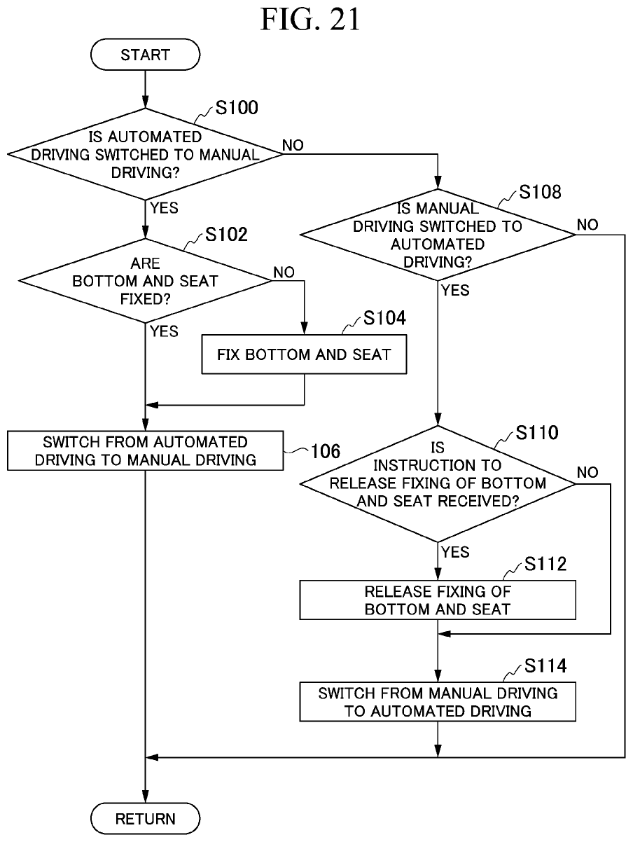

Hereinafter, various vehicle control examples by the vehicle system 1 according to an embodiment will be described. FIG. 21 is a flowchart illustrating an example of a vehicle control process according to an embodiment. The process of FIG. 21 is repeatedly performed, for example, while the vehicle M is stopping or traveling.

In the example of FIG. 21, the switching control unit 142 determines whether the driving mode of the vehicle M is switched from the automated driving to the manual driving (step S100). When the driving mode is switched from the automated driving to the manual driving, the switching control unit 142 determines whether the bottom 41 and the seat 42 are fixed (step S102). When the bottom 41 and the seat 42 are not fixed, the seat control unit 160 fixes the seat 42 to the bottom 41 (step S104).

Subsequently, the switching control unit 142 switches the driving mode of the vehicle M from the automated driving to the manual driving (step S106). When the driving mode is not switched from the automated driving to the manual driving in the process of step S100, the switching control unit 142 determines whether the driving mode is switched from the manual driving to the automated driving (step S108). When the driving mode is switched from the manual driving to the automated driving, it is determined whether an instruction to release the fixing of the bottom and the seat is received from a passenger (step S110). When the instruction to release the fixing of the bottom and the seat is received, the seat control unit 160 releases the fixing of the bottom 41 and the seat 42 (step S112). Subsequently, the switching control unit 142 switches the driving mode of the vehicle M from the manual driving to the automated driving (step S114). Thus, the process of the flowchart ends.

In the example of FIG. 21, a sequence of the processes of the steps may be appropriately exchanged or any step may be omitted. The example of FIG. 21 may be applied to all the seats 42 in the vehicle M or the example may be applied to only the driving seat and the fixing of the seat and the release of the fixing may be switched between in response to an instruction from a passenger with regard to the other seats in the vehicle M.

In the target support device, the vehicle control system, the vehicle control method, and the vehicle control program, and the support structure of the vehicle seat according to the above-described embodiment, it is possible to appropriately adjust an attitude of a target in a vehicle. The vehicle described in the above-described embodiment may be, for example, a train. The embodiment may be applied to a ship, an airplane, and the like.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claim is:

1.-16. (canceled)

17. A target support device comprising:
a bottom configured to be fixed to a floor of a vehicle and have a concave curved surface; and
three or more support members disposed on an upper side of the bottom and configured to come into contact with a convex curved surface formed on a lower surface of a target to support the target and have a surface which is formed as a curved surface,
wherein the target is a seat on which a passenger of the vehicle sits,
wherein the target support device further comprises a seat control unit configured to control a driving unit that moves a position of the seat, and
wherein the seat control unit moves the seat to a predetermined position when the bottom and the seat are fixed.

18. The target support device according to claim 17, further comprising:
a restriction portion configured to restrict a movement range of the support member on the bottom,
wherein displacement of the target is restricted based on a movement range of the support member restricted by the restriction portion.

19. The target support device according to claim 18, wherein the restriction portion is a partition portion that protrudes upward from a curved surface of the bottom to form a wall surface.

20. The target support device according to claim 18, wherein the restriction portion is a concave portion provided on a curved surface of the bottom.

21. The target support device according to claim 17, wherein the seat includes a driving operator that receives at least one operation between steering and an acceleration or deceleration speed of the vehicle.

22. The target support device according to claim 17, further comprising:
a fixing portion that fixes the bottom and the seat.

23. The target support device according to claim 22, wherein the fixing portion fixes the bottom and the seat by inserting a fixing member into each of holes formed in the bottom and the seat or a member connected to the seat.

24. The target support device according to claim 23, wherein a tapered portion which is broadened on an insertion opening side of the fixing member is formed in the hole.

25. The target support device according to claim 21, comprising:
a suppression member configured to suppress a movement amount of the seat with respect to the bottom.

26. A vehicle control system comprising:
the target support device according to claim 17;
an automated driving control unit configured to automatically control at least one of steering and an acceleration or deceleration speed of the vehicle;
a switching control unit configured to switch between automated driving by the automated driving control unit and manual driving by a passenger of the vehicle; and
a seat control unit configured to control a driving unit that moves a position of the seat.

27. The vehicle control system according to claim 26, further comprising:
a travel state recognition unit configured to recognize a travel state of the vehicle,
wherein the seat control unit moves the seat based on a travel state recognized by the travel state recognition unit.

28. The vehicle control system according to claim 26, wherein the seat control unit fixes the bottom and the seat when the automated driving is switched to the manual driving by the automated driving control unit, and the seat control unit releases the fixing of the bottom and the seat when the manual driving is switched to the automated driving.

29. A vehicle control method causing an in-vehicle computer to perform:
automatically controlling at least one of steering and an acceleration or deceleration speed of a vehicle;
switching between automated driving of the vehicle and manual driving by a passenger of the vehicle;
controlling a driving unit that moves a position of a seat by a target support device including a bottom that has a concave curved surface and is fixed to a floor of the vehicle when the automated driving is switched to the manual driving and three or more support members that have a surface which is formed as a curved surface and are disposed on an upper side of the bottom and come into contact with a convex curved surface formed on a lower surface of the seat on which a passenger of the vehicle sits to support the seat; and
causing the driving unit to move the seat to a predetermined position when the bottom and the seat are fixed.

30. A non-transitory computer-readable storage medium that stores an in-vehicle control program to be executed by an in-vehicle computer to perform at least:
automatically controlling at least one of steering and an acceleration or deceleration speed of a vehicle;
switching between automated driving of the vehicle and manual driving by a passenger of the vehicle;
controlling a driving unit that moves a position of a seat by a target support device including a bottom that has a concave curved surface and is fixed to a floor of the vehicle when the automated driving is switched to the manual driving and three or more support members that have a surface which is formed as a curved surface and are disposed on an upper side of the bottom and come into contact with a convex curved surface formed on a lower surface of the seat on which a passenger of the vehicle sits to support the seat; and
causing the driving unit to move the seat to a predetermined position when the bottom and the seat are fixed.

31. A support structure of a vehicle seat mounted in a vehicle,
wherein the seat is displaceable in a direction of an inertial force in accordance with acceleration operated on the vehicle and is returned to an original position in accordance with a decrease in the inertial force, and
wherein the seat is moved to a predetermined position by a driving unit that moves a position of the seat when the seat is fixed.
